(19) United States
(12) Patent Application Publication
(10) Pub. No.: US 2015/0113934 A1
(43) Pub. Date: Apr. 30, 2015

(54) SIDE DECK WEED EATER SYSTEM

(71) Applicant: Scotty Crow, Solgohachia, AR (US)

(72) Inventor: Scotty Crow, Solgohachia, AR (US)

(21) Appl. No.: 14/061,878

(22) Filed: Oct. 24, 2013

(51) Int. Cl. A01D 43/00

(52) U.S. Cl. CPC A01D 43/00
USPC 56/320.1

(57) ABSTRACT

A side deck weed eater system for a lawn mower comprising a weed eater attached to an outer portion of a deck of the lawn mower, where the weed eater includes: a shaft as a central portion of the weed eater, where the shaft is rotated by a belt coupled to a pulley system of the lawn mower; an arm attaching the shaft to the outer portion of the deck; a trimmer base attached to a bottom portion of the shaft; and a trimmer line extending from the trimmer base, where the trimmer line and the trimmer base turn as the shaft is rotated by the belt, wherein the weed eater enables a user to trim and cut a lawn simultaneously while the lawn is mowed.

### BACKGROUND OF THE INVENTION

1. Field of the Invention

The present invention relates to a weed eater that is attached to a side of a lawn mower in order to simultaneously mow and edge a lawn.

2. Description of Related Art

Mowing and trimming a lawn is an integral component of maintaining a beautiful landscape. Many homeowners find taking care of their lawn a necessary chore that must be done on a weekly or bi-weekly basis. Some individuals actually find the task of taking care of their lawn a relaxing or therapeutic activity welcomed one or more times a week. Another type of lawn care is for parks or buildings. These lawns are typically maintained by a professional grounds keeper or company because of their specialized equipment able to handle large grass areas. The professionals often work in teams where one mows while one or more trims, cutting the effort required compared to a single person.

Most of the time a lawn mower is used to shorten the grass and then a weed eater is used to trim the edges of the lawn and the unwanted plants or weeds. By having to use both pieces of equipment, mowing the lawn is a time consuming and tedious task. The individual user must carry the weed eater to the individual portions of the lawn where the mower missed or is unable to reach. Most people are exhausted after having to push a large mower repeatedly over their lawn, so the last thing they want to do is trim. But they know that it is a necessary chore, so lawn care day becomes a dreaded day of the week.

It would be beneficial in the art to provide a device that simplifies mowing and trimming a lawn. It would also be desirable in the art to provide a lawn mower with trimming capabilities to combine the task of mowing and trimming.

### SUMMARY OF THE INVENTION

In view of the foregoing disadvantages inherent in the prior art, the general purpose of the present invention is to provide a weed eater attached to a side deck of a lawn mower, configured to include all of the advantages of the prior art, and to overcome the drawbacks inherent therein.

Accordingly, an object of the present invention is to provide a lawn mower with a weed eater attached to a side portion of the deck.

Another object of the present invention is to provide a lawn mower with an attached weed eater, where the weed eater is operated by the pulley system of the lawn mower.

To achieve the above objects, in an aspect of the present invention, a side deck weed eater system is described comprising a weed eater attached to an outer portion of a deck of the lawn mower, where the weed eater includes: a shaft as a central portion of the weed eater, where the shaft is rotated by a belt coupled to a pulley system of the lawn mower; an arm attaching the shaft to the outer portion of the deck; a trimmer base attached to a bottom portion of the shaft; and a trimmer line extending from the trimmer base, where the trimmer line and the trimmer base turn as the shaft is rotated by the belt, wherein the weed eater enables a user to trim and cut a lawn simultaneously while the lawn is mowed.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a side deck weed eater system in accordance with an exemplary embodiment of the present invention.

### DETAILED DESCRIPTION OF THE DRAWINGS

The present invention relates to a weed eater that is attached to a side of a lawn mower in order to simultaneously mow and edge a lawn. The present invention provides a side deck weed eater to assist a user when maintaining their lawns by allowing for combined mowing and weed trimming. The side deck weed eater is coupled to a pulley system of a lawn mower which is used to operate the weed eater. The side deck weed eater attaches to the side of the lawn mower on a hinge to give the user the option of when to use the weed eater. By providing options for the user, the side deck weed eater is a safe and easy tool to manicure a lawn.

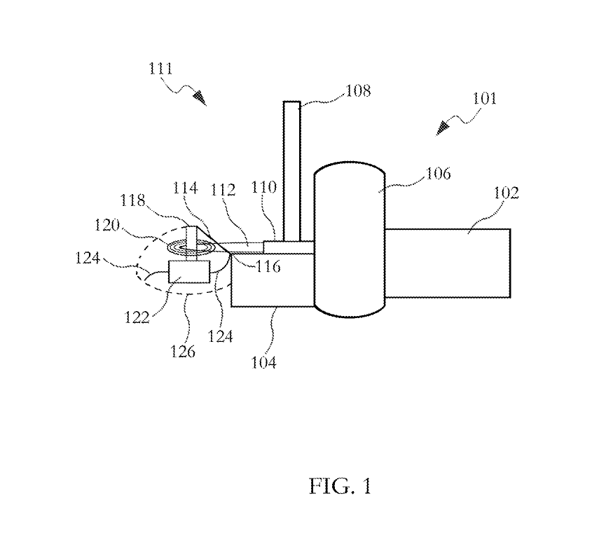

Turning now descriptively to the drawings, referring to FIG. 1, a side deck weed eater system 100 is shown in accordance with an exemplary embodiment of the present invention. The side deck weed eater system 100 combines a lawn mower 101 with a side attached weed eater 111. The lawn mower 101 includes a deck 102, 104 which is positioned on each side of a tire 106. The deck includes an inner portion 102 and an outer portion 104. Positioned on the outer portion of the deck 104 may be a pulley system 110, from which a cable system 108 extends. The pulley system 110 of the lawn mower 101 operates the weed eater 111 allowing it to rotate and cut weeds.

The weed eater 111 is attached to the outer portion of the deck 104 with an arm 114. The arm 114 is attached to the deck 104 on a hinge 116 to enable the weed eater 111 to be lifted when not in use. The arm 114 is attached to a shaft 118 which is centrally positioned within the weed eater 111. The shaft 118 rotates the internal components of the weed eater 111 to trim and cut the weeds. The shaft 118 includes a puller 120 along a central portion. The puller 120 is connected to a belt 112 which is coupled to the pulley system 110 of the lawn mower 101. The belt 112 wraps around the puller 120 so that when the pulley system 110 of the lawn mower 101 rotates the belt 112 the puller 120 in turn rotates the shaft 118.

Fastened to a bottom portion of the shaft 118 is a trimmer base 122. From the trimmer base 122 extends a trimmer line 124. As the shaft 118 rotates, so does the trimmer base 122. During use, the rotating trimmer base 122 whirls the trimmer line 124 at a very rapid rate, so fast that objects encountered by the trimmer line 124 are cut. Within the trimmer base 122 may be a trimmer line spool so that the trimmer line 124 may be extended or shorted as needed by the user. Attached to a top portion of the arm 114 and the shaft 118 may be a shield 126 (illustrated with the dotted line). The shaft 118 protects the user from flying debris while using the weed eater 111. When using the side deck weed eater system 100 the user is afforded the convenience of being able to use a weed eater 111 while they are mowing their lawns. The system 100 saves the user time and energy by allowing the jobs to be done simultaneously, instead of having to mow and then return to the lawn with the separate weed eater to trim and cut the grass edges and weeds.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A side deck weed eater system for a lawn mower comprising:
a. a weed eater attached to an outer portion of a deck of the lawn mower, where the weed eater includes:
i. a shaft as a central portion of the weed eater, where the shaft is rotated by a belt coupled to a pulley system of the lawn mower, where the shaft includes a puller positioned along a central portion, where the belt of the pulley system surrounds the puller to rotate the shaft;
ii. a cable system extending vertically from the pulley system;
iii. an arm attaching the shaft to the outer portion of the deck;
iv. a trimmer base attached to a bottom portion of the shaft; and
v. a trimmer line extending from the trimmer base, where the trimmer line and the trimmer base turn as the shaft is rotated by the belt;
b. wherein the weed eater enables a user to trim and cut a lawn simultaneously while the lawn is mowed.

2. (canceled)

3. The side deck weed eater system according to claim 1, where the arm includes a hinge, where the hinge enables the weed eater to lift on the outer portion of the deck when not in use.

4. The side deck weed eater system according to claim 1, where the weed eater includes a shield attached to a top portion of the shaft, where the shield protects the user from flying debris when mowing the lawn.

5. The side deck weed eater system according to claim 1, where the trimmer base encases a trimmer line spool, where the trimmer line spool enables the trimmer line to extend and retract.
